(19) United States
(12) Patent Application Publication
(10) Pub. No.: US 2020/0309118 A1
(43) Pub. Date: Oct. 1, 2020

(54) ELECTRIC PUMP DEVICE AND MOUNTING STRUCTURE OF ELECTRIC PUMP

(71) Applicant: NIDEC TOSOK CORPORATION, Kanagawa (JP)

(72) Inventors: Hitoshi SAKAMOTO, Kanagawa (JP); Koji HIGUCHI, Kanagawa (JP); Kunihiro KAJITA, Kanagawa (JP); Tomokazu IKEDA, Kanagawa (JP)

(73) Assignee: NIDEC TOSOK CORPORATION, Kanagawa (JP)

(21) Appl. No.: 16/822,038

(22) Filed: Mar. 18, 2020

(30) Foreign Application Priority Data
Mar. 29, 2019 (JP) 2019-068738

(51) Int. Cl. F04C 11/00; H02K 7/14; F04C 15/00; F04C 13/00

(52) U.S. Cl. CPC F04C 11/008; H02K 7/14; F04C 15/0034; F04C 13/001; F04C 2240/803; F04C 2240/30; F04C 2240/805; F04C 2240/40; F04C 2210/206

(57) ABSTRACT

Provided is an electric pump device which includes a motor having a shaft extending along a first central axis, a pump portion driven by the motor, and a housing for housing the motor and the pump portion. The housing includes: a housing body portion which has a bottomed tube shape and extends in an axial direction, a flange portion which expands radially outward from an outer peripheral surface of the housing body portion, a seal portion which has a ring shape extending in a circumferential direction and is arranged at a corner portion in which the outer peripheral surface of the housing body portion and an end surface facing one axial side of the flange portion are connected, and a projection portion extending from a bottom portion of the housing body portion toward one axial side. A second central axis of the projection portion is arranged at a position shifted in a radial direction from the first central axis. The flange portion has positioning portions on the end surface facing the one axial side of the flange portion. The positioning portions have a convex shape projected from the end surface facing the one axial side of the flange portion toward the one axial side or a hole shape recessed from the end surface toward the other axial side.

### CROSS REFERENCE TO RELATED APPLICATIONS

The present invention claims priority under 35 U.S.C. § 119 to Japanese Application No. 2019-068738, filed on Mar. 29, 2019. The entire content of which is incorporated herein by reference.

### FIELD OF THE INVENTION

The disclosure relates to an electric pump device and a mounting structure of electric pump.

### BACKGROUND

An electric pump unit is a unit in which a pump and a pump driving electric motor are integrated with a lid. The electric pump unit is disposed in a recess formed by a bottomed circular hole opened in a rear surface of a vertical wall of a transmission housing. A cylindrical portion of the lid is closely fitted to a rear portion of the recess, and an outward flange is in contact with the rear surface of the vertical wall of the housing around the recess via an O-ring and fixed by a bolt or the like. An oil discharge pipe of the pump is closely fitted in a through hole formed in a bottom wall of the recess.

Since the oil discharge pipe is fitted into the through hole while the cylindrical portion of the lid is fitted in the recess, it is difficult to align and assemble. For example, it is conceivable to arrange a gap between an outer peripheral surface of the cylindrical portion and an inner peripheral surface of the recess, but in this case, there is a possibility that the center of the recess and the center of the cylindrical portion are easily shifted from each other in a radial direction, and the sealing performance of the O-ring varies at each position in a circumferential direction and between an inner end portion and an outer end portion in the radial direction.

It should be noted that the introduction in Background is merely provided for the convenience of clearly and comprehensively describing the technical solutions of the disclosure and facilitating the understanding of those skilled in the art. These technical solutions shall not be deemed well-known by those skilled in the art simply for having been described in Background.

### SUMMARY

An example embodiment of present disclosure provides an electric pump device. The electric pump device includes a motor having a shaft extending along a first central axis; a pump portion driven by the motor; and a housing for housing the motor and the pump portion. The housing includes a housing body portion which has a bottomed tube shape and extends in an axial direction, a flange portion which expands radially outward from an outer peripheral surface of the housing body portion, a seal portion which has a ring shape extending in a circumferential direction and is arranged at a corner portion in which the outer peripheral surface of the housing body portion and an end surface facing one axial side of the flange portion are connected, and a projection portion extending from a bottom portion of the housing body portion toward one axial side. A second central axis of the projection portion is arranged at a position shifted in a radial direction from the first central axis. The flange portion has positioning portions on the end surface facing the one axial side of the flange portion. The positioning portions have a convex shape projected from the end surface facing the one axial side of the flange portion toward the one axial side or a hole shape recessed from the end surface toward the other axial side.

An example embodiment of the disclosure provides a mounting structure of electric pump. The mounting structure includes the electric pump device described above, and a mounted object to which the electric pump device is mounted. The mounted object includes: a mounting surface facing the other axial side and in contact with the end surface facing one axial side of the flange portion; a recess which is recessed from the mounting surface toward one axial side and into which the housing body portion is inserted; an in-port which opens in a bottom surface of the recess and extends in the axial direction and into which the projection portion is inserted; and a corner which has a ring shape extending in the circumferential direction and in which an inner peripheral surface of the recess and the mounting surface are connected. The inner peripheral surface of the recess faces the outer peripheral surface of the housing body portion with a gap therebetween in the radial direction. The seal portion is arranged clamped by the corner and the corner portion. The mounting surface has mounting surface positioning portions into which the positioning portions are fitted. The mounting surface positioning portions have a hole shape recessed from the mounting surface toward one axial side or a convex shape projected from the mounting surface toward the other axial side.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a perspective view showing an electric pump device of the embodiment.

FIG. 2 is a bottom view showing the electric pump device of the embodiment.

FIG. 3 is a longitudinal cross-sectional view of the electric pump device and a mounting structure of electric pump of the embodiment, showing a cross section along line of FIG. 2.

FIG. 4 is a longitudinal cross-sectional view showing a part of FIG. 3 in an enlarged manner.

FIG. 5 is a side view showing a part of a housing body portion and a press-fitting jig.

FIG. 6 is a longitudinal cross-sectional view showing a first modification example of the electric pump device and the mounting structure of electric pump of the embodiment.

FIG. 7 is a longitudinal cross-sectional view showing a second modification example of the electric pump device and the mounting structure of electric pump of the embodiment.

FIG. 8 is a longitudinal cross-sectional view showing a third modification example of the electric pump device and the mounting structure of electric pump of the embodiment.

### DESCRIPTION OF THE EMBODIMENTS

The foregoing and other features of the disclosure will become apparent from the following specification with reference to the accompanying drawings. Specific embodiments of the disclosure are disclosed in the specification and the accompanying drawings. The specification and the accompanying drawings describe several embodiments to which the principles of the disclosure are applicable. However, it should be understood that, the disclosure is not limited to the embodiments described herein, but shall include all modifications, variations and equivalents falling within the scope of the appended claims.

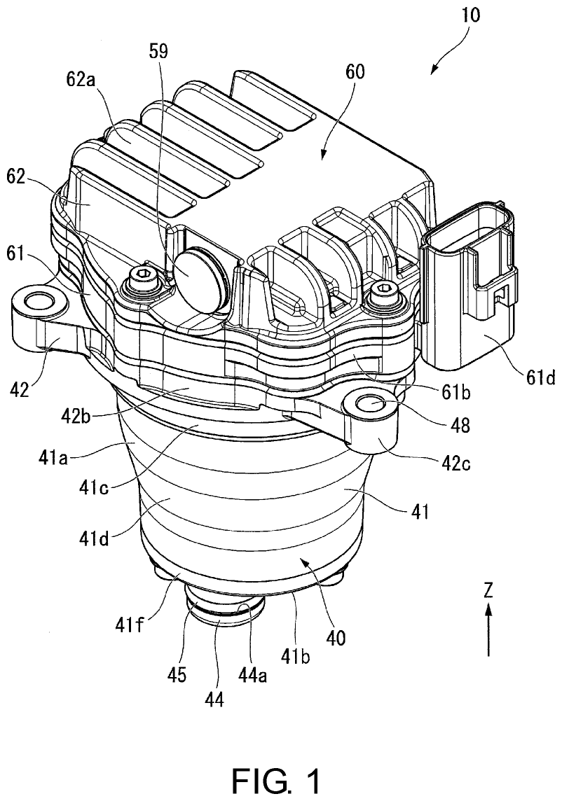

An electric pump device 10 and a mounting structure of electric pump 80 according to an embodiment of the disclosure will be described with reference to the drawings. In the drawings, an XYZ coordinate system is appropriately shown as a three-dimensional orthogonal coordinate system. As shown in FIG. 1-FIG. 3, the electric pump device 10 includes a motor 20, a pump portion 30, a housing 40, an inverter case 60, a circuit board 55, wiring members 56, bus bars 58, an inverter 50, a capacitor 57, and a breather 59. The mounting structure of electric pump 80 includes the electric pump device 10, a mounted object 100 to which the electric pump device 10 is mounted, and screw members 105.

The motor 20 includes a shaft 22 which extends along a first central axis J1, and the first central axis J1 extends along a Z-axis direction. Moreover, the first central axis J1 may simply be referred to as the central axis J1. In the following description, a direction parallel to the first central axis J1 is simply referred to as an “axial direction”. In the embodiment, an axial position of the motor 20 and an axial position of the inverter 50 are different from each other. That is, the motor 20 and the inverter 50 are arranged at different positions in the axial direction. In the axial direction, a direction from the inverter 50 toward the motor 20 is referred to as one axial side (−Z side), and a direction from the motor 20 toward the inverter 50 is referred to as the other axial side (+Z side). An X-axis direction is a direction orthogonal to the Z-axis direction. AY-axis direction is a direction orthogonal to the Z-axis direction and the X-axis direction. The Y-axis direction is an inter-axis direction described later.

A radial direction centered on the first central axis J1 is simply referred to as a “radial direction”. In the radial direction, a direction approaching the first central axis J1 is referred to as a radial inner side, and a direction away from the first central axis J1 is referred to as a radial outer side. A circumferential direction centered on the first central axis J1, that is, a direction around the first central axis J1, is simply referred to as a “circumferential direction”. Moreover, in the embodiment, a “parallel direction” includes a substantially parallel direction, and an “orthogonal direction” includes a substantially orthogonal direction.

The electric pump device 10 of the embodiment sucks and discharges, for example, fluid such as oil or the like. The electric pump device 10 has, for example, a function of circulating a fluid through a flow path. When the fluid is oil, the electric pump device 10 may be referred to as an electric oil pump device. In the embodiment, the electric pump device 10 is mounted to the mounted object 100 which is a housing of a vehicle drive device. That is, the electric pump device 10 is mounted on a vehicle.

The mounted object 100 includes a mounting surface 110, a recess 101, an in-port 102, an out-port 103, and a corner 104. The mounting surface 110 faces the other axial side. The recess 101 is recessed from the mounting surface 110 toward the one axial side. The recess 101 has a bottomed circular hole shape. The in-port 102 opens in a bottom surface 101a of the recess 101 and extends in the axial direction. The in-port 102 has a circular hole shape. The out-port 103 opens in the recess 101 at a position different from the in-port 102. In the embodiment, the out-port 103 opens in an inner peripheral surface 101b of the recess 101. The corner 104 has a ring shape extending in the circumferential direction, and is a part where the inner peripheral surface 101b of the recess 101 and the mounting surface 110 are connected. The corner 104 has an annular shape. The electric pump device 10 sucks oil from the in-port 102 by the pump portion 30 and discharges oil from the out-port 103.

The motor 20 includes a rotor portion 21, a stator portion 26, and a plurality of bearings 11, 12. The rotor portion 21 includes a shaft 22, a rotor core 23, a magnet 24, and a magnet holder 25.

The shaft 22 extends in the axial direction centered on the first central axis J1. The shaft 22 rotates around the first central axis J1. The shaft 22 is supported by the plurality of bearings 11, 12 so as to be rotatable around the first central axis J1. That is, the plurality of bearings 11, 12 rotatably supports the shaft 22. The plurality of bearings 11, 12 is, for example, ball bearings or the like. Of the plurality of bearings 11, 12, the first bearing 11 supports a part of the shaft 22 which is positioned closer to the one axial side than the rotor core 23. Of the plurality of bearings 11, 12, the second bearing 12 supports a part of the shaft 22 which is positioned closer to the other axial side than the rotor core 23.

The rotor core 23 is fixed to an outer peripheral surface of the shaft 22. The rotor core 23 has a ring shape centered on the first central axis J1. The rotor core 23 has a tube shape extending in the axial direction. The rotor core 23 is configured, for example, by laminating a plurality of electromagnetic steel plates in the axial direction.

The magnet 24 is disposed at a radial outer end portion of the rotor core 23. In the embodiment, the magnet 24 is an embedded magnet. Moreover, the magnet 24 may be a surface magnet. A plurality of the magnets 24 is arranged. The plurality of magnets 24 is disposed on the radial outer end portion of the rotor core 23 at intervals in the circumferential direction. Moreover, the magnet 24 may be, for example, a single cylindrical ring magnet.

The magnet holder 25 is arranged on the rotor core 23 and holds the magnet 24. In the embodiment, the magnet holder 25 prevents the magnet 24 from coming out of the rotor core 23 in the axial direction. The magnet holder 25 is disposed on a surface facing a radially outer surface of the rotor core 23, the one axial side and the other axial side.

The stator portion 26 is disposed radially outside the rotor portion 21, and faces the rotor portion 21 with a gap therebetween in the radial direction. That is, the stator portion 26 faces the rotor portion 21 in the radial direction. The stator portion 26 surrounds the rotor portion 21 from the outside in the radial direction over the entire circumference in the circumferential direction. The stator portion 26 includes a stator core 27, an insulator 28, and a plurality of coils 29.

The stator core 27 has a ring shape centered on the first central axis J1. The stator core 27 surrounds the rotor portion 21 from the outside in the radial direction. The stator core 27 is disposed radially outside the rotor part 21, and faces the rotor part 21 with a gap therebetween in the radial direction. The stator core 27 is configured, for example, by laminating a plurality of electromagnetic steel plates in the axial direction.

The stator core 27 includes a core back 27a and a plurality of teeth 27b. The core back 27a has a ring shape centered on the central axis. The core back 27a has a tube shape extending in the axial direction. A radially outer surface of the core back 27a is fixed to an inner peripheral surface of the housing 40. The core back 27a is fitted into the housing 40. The teeth 27b extend radially inward from a radially inner side surface of the core back 27a. The plurality of teeth 27b is disposed on the radially inner side surface of the core back 27a at intervals in the circumferential direction.

The insulator 28 is attached to the stator core 27. The insulator 28 has a part which covers the teeth 27b. A material of the insulator 28 is, for example, an insulation material such as a resin or the like.

The plurality of coils 29 is mounted to the stator core 27 via the insulator 28. That is, the plurality of coils 29 is mounted to the stator core 27. The plurality of coils 29 is respectively configured by winding a conductive wire around each tooth 27b via the insulator 28.

Although not particularly illustrated, the plurality of coils 29 includes a first coil, a second coil, and a third coil. The first coil has a first conductive wire. The second coil has a second conductive wire different from the first conductive wire. The third coil has a third conductive wire different from the first conductive wire and the second conductive wire. The first coil, the second coil, and the third coil have phases different from each other. In the embodiment, the motor 20 is a three-phase motor. The three phases are U phase, V phase and W phase. In the case of a three-phase motor, the conductive wires configuring each of the U-phase, V-phase, and W-phase coils 29 are different from each other. That is, the conductive wire of the U-phase coil 29, the conductive wire of the V-phase coil 29, and the conductive wire of the W-phase coil 29 are different from each other.

The coils 29 include winding wire portions 29a wound around a part of the stator core 27, crossover wire portions 29b connected to the winding wire portions 29a and connecting the plurality of coils 29, and lead wire portions 29c connected to the winding wire portions 29a and connecting the coils 29 and the bus bars 58. The winding wire portions 29a are configured by winding a conductive wire around the teeth 27b via the insulator 28. The crossover wire portions 29b connect a plurality of the winding wire portions 29a formed of a single conducting wire. The crossover wire portions 29b are disposed on the other axial side or one axial side of the stator core 27. The crossover wire portions 29b have parts extending along a virtual plane (not shown) perpendicular to the first central axis J1. The lead wire portions 29c are drawn from the winding wire portions 29a to the other axial side and are connected to the circuit board 55 via the bus bars 58.

The pump portion 30 is driven by the motor 20. The pump portion 30 is arranged closer to the one axial side than the stator portion 26 and is connected to the rotor portion 21. In the embodiment, the pump portion 30 has a trochoid pump structure. The pump portion 30 includes an inner rotor 30a and an outer rotor 30b positioned radially outside the inner rotor 30a. The inner rotor 30a and the outer rotor 30b are pump gears and mesh with each other. Each of the inner rotor 30a and the outer rotor 30b has a trochoidal tooth profile. The inner rotor 30a is fixed to an end portion on one axial side of the shaft 22. The motor 20 drives the pump portion 30 by rotating the inner rotor 30a.

The housing 40 houses the motor 20 and the pump portion 30. The housing 40 includes a housing body portion 41, a projection portion 44, a seal portion 43, and a flange portion 42 expanding radially outward from an outer peripheral surface of the housing body portion 41.

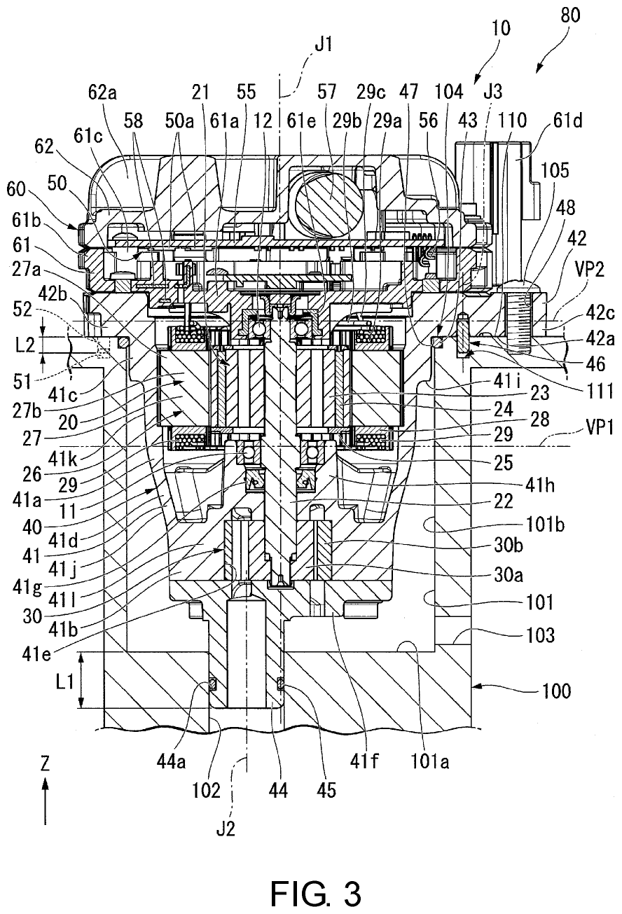

The motor 20 and the pump portion 30 are housed in the housing body portion 41. The housing body portion 41 has a tube shape and extends in the axial direction. The housing body portion 41 has a bottomed tube shape and has a peripheral wall portion 41a and a bottom portion 41b. The stator core 27 is fitted in the peripheral wall portion 41a. The bottom portion 41b closes an end portion on one axial side of the peripheral wall portion 41a. As shown in FIG. 3, the housing body portion 41 is inserted into the recess 101 of the mounted object 100. The inner peripheral surface 101b of the recess 101 faces an outer peripheral surface of the housing body portion 41 with a gap therebetween in the radial direction.

The housing body portion 41 includes a cylindrical portion 41c, a stepped surface 41i, a weight-shaped portion 41d, a pump housing wall portion 411, a pump housing hole 41e, a bearing holding tube portion 41h, a pump cover 41f, and an oil seal 41g. The cylindrical portion 41c, the stepped surface 41i, and the weight-shaped portion 41d are arranged on the peripheral wall portion 41a. The pump housing wall portion 411, the pump housing hole 41e, the bearing holding tube portion 41h, the pump cover 41f, and the oil seal 41g are arranged on the bottom portion 41b.

The cylindrical portion 41c is disposed at the end portion at the other axial side of the housing body portion 41. The cylindrical portion 41c has a cylindrical shape centered on the first central axis J1 and extends in the axial direction. An outer peripheral surface of the cylindrical portion 41c is connected to an end surface 42a of the flange portion 42 facing the one axial side. The stepped surface 41i is an annular surface centered on the first central axis J1, and faces the one axial side. An outer peripheral portion of the stepped surface 41i is connected to an end portion on one axial side of the cylindrical portion 41c.

The weight-shaped portion 41d is positioned closer to the one axial side than the flange portion 42. The weight-shaped portion 41d is positioned closer to the one axial side than the cylindrical portion 41c and the stepped surface 41i. An end portion at the other axial side of the weight-shaped portion 41d is connected to an inner peripheral portion of the stepped surface 41i. The weight-shaped portion 41d is arranged in a part other than the end portion at the other axial side of the peripheral wall portion 41a.

An outer diameter of the weight-shaped portion 41d decreases toward the one axial side. In the embodiment, as shown in FIG. 3, in a longitudinal cross-sectional view along the first central axis J1, an inclination angle of a part 41j with respect to the first central axis J1 is larger than an inclination angle of a part 41k with respect to the first central axis J1, the of a part 41k being positioned on the one axial side of the weight-shaped portion 41d, the part 41k being positioned on the other axial side of the weight-shaped portion 41d. That is, in the longitudinal cross-sectional view, an amount of displacement (that is, inclination) toward the radial direction per unit length along the axial direction in the part 41j positioned on the one axial side of the weight-shaped portion 41d is larger than an amount of displacement toward the radial direction per unit length along the axial direction in the part 41k positioned on the other axial side of the weight-shaped portion 41d.

According to the embodiment, since the housing body portion 41 has the weight-shaped portion 41d, a gap can be arranged between the inner peripheral surface 101b of the recess 101 of the mounted object 100 and the weight-shaped portion 41d. In addition, this gap is larger than a gap between the inner peripheral surface 101b of the recess 101 and the cylindrical portion 41c. That is, in the embodiment, a gap is arranged between the outer peripheral surface of the housing body portion 41 and the inner peripheral surface 101b of the recess 101, and oil can flow through this gap, and thus an effect of cooling the motor 20 by the oil is obtained.

The pump housing wall portion 411 is connected to an end portion at one axial side of the weight 41d. The pump housing wall portion 411 closes the end portion at the one axial side of the peripheral wall portion 41a. The pump housing wall portion 411 has a disk shape with plate surfaces facing the axial direction.

The pump housing hole 41e is recessed from a plate surface facing the one axial side of the pump housing wall portion 411 toward the other axial side. In the embodiment, the pump housing hole 41e has a crested circular hole shape. The pump portion 30 is disposed in the pump housing hole 41e. The bearing holding tube portion 41h has a tube shape extending from the pump housing wall portion 411 toward the other axial side. The bearing holding tube portion 41h is projected from a plate surface facing the other axial side of the pump housing wall portion 411 toward the other axial side. The bearing holding tube portion 41h holds the first bearing 11. The first bearing 11 is fitted in the bearing holding tube portion 41h.

The pump cover 41f is fixed to the plate surface facing the one axial side of the pump housing wall portion 411, and covers the pump portion 30 from the one axial side. The oil seal 41g has a ring shape centered on the first central axis J1. The oil seal 41g is disposed in the bearing holding tube portion 41h, and is positioned closer to the one axial side than the first bearing 11.

The projection portion 44 has a tube shape extending in the axial direction. The projection portion 44 has a cylindrical shape and may be referred to as a tube portion. The projection portion 44 extends from the bottom portion 41b of the housing body portion 41 toward the one axial side. In the embodiment, the projection portion 44 is projected from the pump cover 41f toward the one axial side. The projection portion 44 extends in the axial direction centered on a second central axis J2. The second central axis J2 of the projection portion 44 is arranged at a position which is shifted in the radial direction from the first central axis J1. The second central axis J2 and the first central axis J1 extend in parallel to each other.

The projection portion 44 is inserted into and in contact with the in-port 102. That is, the projection portion 44 is inserted into the in-port 102. The projection portion 44 includes a groove portion 44a and an elastic ring member 45. The groove portion 44a is disposed in an outer peripheral surface of the projection portion 44 and extends around the second central axis J2. The groove portion 44a is a ring-shaped groove centered on the second central axis J2. The elastic ring member 45 has a ring shape fitting on the outer peripheral surface of the projection portion 44 and can be elastically deformed. The elastic ring member 45 is, for example, an O-ring or the like. The elastic ring member 45 is disposed in the groove portion 44a and extends around the second central axis J2.

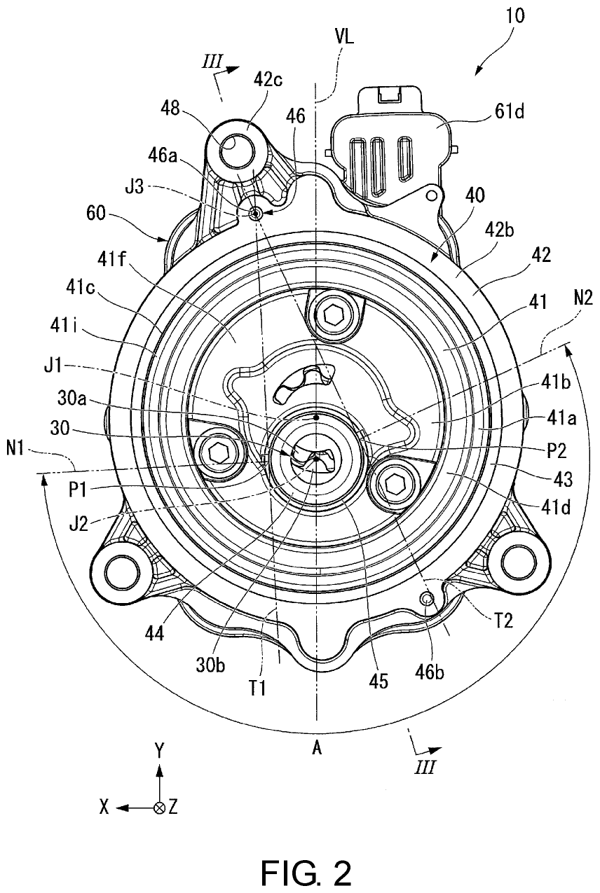

In the embodiment, as shown in FIG. 2, a direction in which a virtual straight line VL extends which passes through the first central axis J1 and the second central axis J2 when the housing 40 is viewed from the axial direction is defined as the inter-axis direction. In FIG. 2, the inter-axis direction is a direction extending along the Y axis. In the inter-axis direction, a direction from the second central axis J2 toward the first central axis J1 is a +Y side. In the inter-axis direction, a direction from the first central axis J1 toward the second central axis J2 is the −Y side.

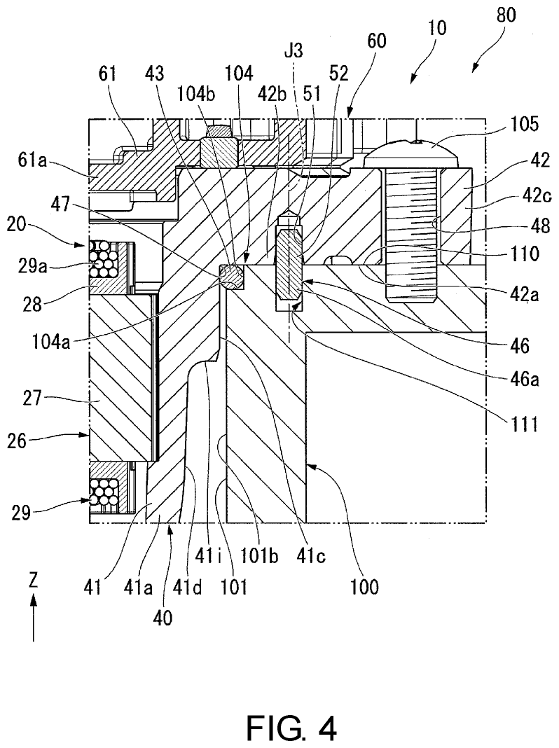

The seal portion 43 has a ring shape extending in the circumferential direction. The seal portion 43 has an annular shape centered on the first central axis J1. As shown in FIG. 3 and FIG. 4, the seal portion 43 is disposed at a corner portion 47 where the outer peripheral surface of the housing body portion 41 and the end surface 42a facing the one axial side of the flange portion 42 are connected. In the embodiment, the seal portion 43 has a circular cross section along the radial direction. The seal portion 43 is, for example, an O-ring or the like and can be elastically deformed. The seal portion 43 is disposed clamped between the corner 104 and the corner portion 47. The seal portion 43 seals the space between the corner 104 and the corner portion 47. In the embodiment, the corner 104 includes a bottom wall 104a and an inner peripheral wall 104b.

The bottom wall 104a is positioned closer to the one axial side than the mounting surface 110 and faces the other axial side. The bottom wall 104a has a planar shape expanding in a direction perpendicular to a central axis (corresponding to the first central axis J1) of the recess 101. The bottom wall 104a has a ring shape centered on the central axis of the recess 101. The inner peripheral wall 104b is positioned radially outside the inner peripheral surface 101b of the recess 101 and faces radially inward. The inner peripheral wall 104b has a ring shape centered on the central axis of the recess 101. An end portion on one axial side of the inner peripheral wall 104b and an outer peripheral portion of the bottom wall 104a are connected to each other. According to the embodiment, the seal portion 43 is disposed clamped between the bottom wall 104a and the inner peripheral wall 104b of the corner 104 of the mounted object 100 and the corner portion 47 of the housing 40. The corner 104 can be easily processed, and the sealing performance of the seal portion 43 is stabilized.

As shown in FIG. 1-FIG. 4, the flange portion 42 includes a flange portion body 42b and mounting portions 42c. The flange portion body 42b has an annular shape centered on the first central axis J1. The mounting portions 42c are projected radially outward from the flange portion body 42b. In the embodiment, a plurality of the mounting portions 42c is arranged at intervals in the circumferential direction. Each mounting portion 42c is fixed to the mounting surface 110 of the mounted object 100 by the screw members 105.

The flange portion 42 includes the end surface 42a facing the one axial side, positioning portions 46, hole portions 51, pin portions 52, and mounting holes 48. The end surface 42a is disposed across the flange portion body 42b and the mounting portions 42c. The end surface 42a has a planar shape expanding in a direction orthogonal to the first central axis J1. The mounting surface 110 is in contact with the end surface 42a and has a planar shape expanding in a direction orthogonal to the central axis of the recess 101.

As shown in FIG. 3, in the axial direction, the end surface 42a is disposed between a first virtual plane VP1 and a second virtual plane VP2, the first virtual plane VP1 expanding in the direction orthogonal to the first central axis (the central axis) J1 passing through a part which is positioned closest to the one axial side among the stator core 27, the winding wire portions 29a and the crossover wire portions 29b, the second virtual plane VP2 expanding in the direction orthogonal to the first central axis J1 passing through a part which is positioned closest to the other axial side among the stator core 27, the winding wire portions 29a and the crossover wire portions 29b. That is, an axial position of the end surface 42a is between an axial position of the part which is positioned closest to the one axial side among the stator core 27, the winding wire portions 29a and the crossover wire portions 29b, and an axial position of the part which is positioned closest to the other axial side among the stator core 27, the winding wire portions 29a and the crossover wire portions 29b.

A ratio of a weight of the stator portion 26 to a total weight of the electric pump device 10 is large. Therefore, for example, in a case that unlike the embodiment, a center of gravity of the stator portion 26 is separated in the axial direction from a fixed surface of the electric pump device 10 to the mounted object 100, that is, the end surface 42a facing the one axial side of the flange portion 42, the electric pump device 10 is likely to vibrate.

In contrast, in the electric pump device 10 of the embodiment, the end surface 42a facing the one axial side of the flange portion 42 is arranged in the axial direction in a range where the stator core 27, the winding wire portions 29a and the crossover wire portions 29b in the stator portion 26 are positioned. The center of gravity of the stator portion 26 is positioned on any of the stator core 27, the winding wire portions 29a, and the crossover wire portions 29b. That is, according to the embodiment, the end surface 42a facing the one axial side of the flange portion 42 is disposed close to the center of gravity of the stator portion 26 in the axial direction. Thereby, the electric pump apparatus 10 can be suppressed from vibrating. Specifically, vibration generated by operation of the electric pump device 10 can be suppressed. In addition, when the mounted object 100 is a housing of a vehicle drive device as in the embodiment, vibration caused by operation of the drive device or vibration generated due to traveling of the vehicle is suppressed from vibrating (resonating) the electric pump device 10.

The end surface 42a is disposed closer to the other axial side than the stator core 27 in the axial direction. According to the embodiment, the end surface 42a facing the one axial side of the flange portion 42 is disposed in the axial direction in a range of a part of the winding wire portions 29a and the crossover wire portions 29b which is positioned closer to the other axial side than the stator core 27. In this case, the effect of suppressing the vibration of the electric pump device 10 is obtained as described above, and a projected amount of the electric pump device 10 projected from the mounting surface 110 of the mounted object 100 toward the other side in the axial direction can be suppressed. Thereby, an installation space for other members can be secured on the other axial side of the electric pump device 10. In addition, overall external dimensions of the electric pump device 10 and the mounted object 100 can be kept small.

Moreover, generally, in the configuration in which the gap is arranged between the outer peripheral surface of the housing body portion 41 and the inner peripheral surface 101b of the recess 101, the electric pump device 10 may easily vibrate, but according to the embodiment, the fixing surface of the electric pump device 10 to the mounted object 100, that is, the end surface 42a facing the one axial side of the flange portion 42 is disposed close to the center of gravity of the stator portion 26 in the axial direction, and thus the vibration can be suppressed.

In addition, in the embodiment, the projection portion 44 is inserted into the in-port 102 of the mounted object 100. Since the elastic ring member 45 is interposed between the outer peripheral surface of the projection portion 44 and the in-port 102, the sealing performance between the projection portion 44 and the in-port 102 is secured, and the elastic ring member 45 functions as a cushioning material (a vibration suppression material) between the electric pump device 10 and the mounted object 100. Therefore, the vibration is further suppressed.

The positioning portions 46 are arranged on the end surface 42a. That is, the flange portion 42 has the positioning portions 46 on the end surface 42a. The positioning portions 46 are disposed on the flange portion body 42b. The positioning portions 46 has a convex shape projected from the end surface 42a toward the one axial side or a hole shape recessed from the end surface 42a toward the other axial side. In the embodiment, the positioning portion 46 has a convex shape projected from the end surface 42a toward the one axial side. Therefore, the positioning portions 46 may be referred to as the convex portions 46. That is, the flange portion 42 has the convex portions 46 which are projected from the end surface 42a toward the one axial side. At least one or more convex portions 46 are arranged on the flange portion 42. The positioning portions 46 extend in the axial direction centered on a third central axis J3. The third central axis J3 is parallel to the first central axis J1 and the second central axis J2.

The mounting surface 110 has mounting surface positioning portions 111 into which the positioning portions 46 are fitted. The mounting surface positioning portions 111 have a hole shape recessed from the mounting surface 110 toward the one axial side or a convex shape projected from the mounting surface 110 toward the other axial side. In the embodiment, the mounting surface positioning portions 111 has the a shape recessed from the mounting surface 110 toward the one axial side. Therefore, the mounting surface positioning portions 111 may be referred to as the insertion holes 111. That is, the mounting surface 110 has the insertion holes 111 recessed from the mounting surface 110 toward the one axial side. The positioning portions 46 (the convex portions 46) are inserted into and in contact with the mounting surface positioning portions 111 (the insertion holes 111). That is, the positioning portions 46 are inserted into the mounting surface positioning portions 111.

In the electric pump device 10 and the mounting structure of electric pump 80 of the embodiment, the seal portion 43 is disposed clamped between the corner portion 47 of the housing 40 and the corner 104 of the mounted object 100. For example, compared with a configuration which is different from the embodiment and in which a ring-shaped housing groove which opens in the axial direction and extends in the circumferential direction is arranged on the end surface 42a facing the one axial side of the flange portion 42 or arranged on the mounting surface 110 of the mounted object 100, according to the embodiment, an outer diameter of the flange portion 42 can be kept small. Therefore, the electric pump device 10 can be reduced in size. In addition, in the embodiment, since a diameter of the corner 104 of the mounted object 100 is smaller than a diameter of the above-described housing groove, a deflection width during the cutting of the corner 104 is kept small, processing precision of flatness, perpendicularity or the like is improved, and the sealing performance at the corner 104 is enhanced.

In addition, for example, compared with a configuration which is different from the embodiment and in which a ring-shaped housing groove which opens in the radial direction and extends in the circumferential direction is arranged on the outer peripheral surface of the housing body portion 41 or arranged on the inner peripheral surface 101b of the recess 101, and the seal portion is housed in the housing groove, in the embodiment, groove processing on the housing 40 is unnecessary and processing on the corner 104 of the mounted object 100 is simpler. Therefore, processing time during manufacturing can be shortened, and manufacturing cost or tact time can be reduced.

Besides, in the embodiment, the positioning portions 46 are arranged on the end surface 42a facing the one axial side of the flange portion 42. By fitting the positioning portions 46 of the electric pump device 10 with the mounting surface positioning portions 111 of the mounting surface 110 of the mounted object 100, that is, by inserting the convex portions 46 of the flange portion 42 into the insertion holes 111 of the mounting surface 110, the housing body portion 41 of the electric pump device 10 and the recess 101 of the mounted object 100 are arranged coaxially in a manner that their center axes coincide with each other. Thereby, a distance between the corner portion 47 of the housing 40 and the corner 104 of the mounted object 100 becomes constant along the circumferential direction, and the sealing performance of the seal portion 43 is stabilized over the entire circumference. Therefore, the sealing performance between the electric pump device 10 and the mounted object 100 can be prevented from varying in the circumferential direction and the radial direction. That is, the sealing performance between the electric pump device 10 and the mounted object 100 can be suppressed from varying at each position in the circumferential direction of the seal portion 43, or between the inner end portion and the outer end portion in the radial direction of the seal portion 43.

In addition, in the embodiment, as described above, the sealing performance is stabilized and it is not necessary to fit the outer peripheral surface of the housing body portion 41 and the inner peripheral surface 101b of the recess 101, and when the electric pump device 10 is mounted to the mounted object 100, the degree of freedom of relative movement of both members is secured. That is, while inserting and fitting the projection portion 44 of the housing 40 into the in-port 102 of the mounted object 100, the positioning portions 46 (the convex portions 46) of the housing 40 are easily inserted and fitted into the mounting surface positioning portions 111 (the insertion holes 111) of the mounting surface 110 of the mounted object 100. Therefore, the electric pump device 10 and the mounted object 100 are easily assembled. In addition, for example, in a configuration which is unlike the embodiment and in which the outer peripheral surface of the housing body portion 41 is fitted with the inner peripheral surface 101b of the recess 101, there is a risk that increase of internal stress or displacement is generated in the stator portion 26 fitted into the housing body portion 41 at the time of assembly; however, in the embodiment, the generation of stress in the stator portion 26 is suppressed, and the performance of the motor 20 is satisfactorily maintained. In addition, by arranging a gap between the outer peripheral surface of the housing body portion 41 and the inner peripheral surface 101b of the recess 101, the oil can flow through this gap, and the cooling effect by the oil can be obtained.

As shown in FIG. 2, the positioning portions 46 (the convex portions 46) are arranged closer to the direction (+Y side) from the second central axis J2 toward the first central axis J1 in the inter-axis direction than the projection portion 44. According to the embodiment, the positioning portions 46 are disposed at positions away from the projection portion 44 in the flange portion 42. That is, a large distance between the projection portion 44 and the positioning portions 46 is secured. Therefore, the projection portion 44 is fitted into the in-port 102 and the positioning portions 46 are fitted into the mounting surface positioning portions 111 in a state that a large inter-axial distance between the second central axis J2 of the projection portion 44 and the third central axis J3 of the positioning portions 46 is secured. Thereby, position deviation in the circumferential direction between the housing 40 of the electric pump device 10 and the recess 101 of the mounted object 100 is suppressed, precision of circumferential positions is improved, and precision of a coaxial degree between the housing 40 and the recess 101 is improved. The distance between the corner portion 47 of the housing 40 and the corner 104 of the mounted object 100 is unlikely to vary at each position in the circumferential direction, and the sealing performance of the seal portion 43 is further stabilized.

Two positioning portions 46 (convex portions 46) are arranged on the flange portion 42. According to the embodiment, since two positioning portions 46 are arranged, the precision of the coaxial degree between the housing 40 of the electric pump device 10 and the recess 101 of the mounted object 100 is further stabilized. Specifically, for example, compared with a configuration in which only one positioning portion 46 is arranged, in the embodiment, precision of the radial position and precision of the circumferential position of the housing 40 with respect to the recess 101 of the mounted object 100 are improved. In addition, for example, in a configuration in which three positioning portions 46 are arranged, two of the three positioning portions 46 are in contact with the mounting surface positioning portions 111 (the insertion holes 111), but one is difficult to come into contact with the mounting surface positioning portion 111, and thus, it is difficult to obtain the positioning function in the one positioning portion 46. In addition, in order to fit the three positioning portions 46 respectively to the mounting surface positioning portions 111, fitting tolerance must be increased, and rattling (gap) after the assembly increases accordingly, and positioning precision may decrease.

In the embodiment, the two positioning portions 46 (convex portions 46) are a first positioning portion 46a and a second positioning portion 46b. The first positioning portion 46a may also be referred to as the first convex portion 46a. The second positioning portion 46b may also be referred to as the second convex portion 46b. That is, the two convex portions 46 are the first convex portion 46a and the second convex portion 46b. As shown in FIG. 2, when the housing 40 is viewed from the axial direction, two tangent lines which pass through the third central axis J3 of the first positioning portion 46a and are tangent to the outer peripheral surface of the projection portion 44 are a first tangent line T1 and a second tangent line T2. When the housing 40 is viewed from the axial direction, a normal line of the first tangent line T1 which passes through a first tangent point P1 being a tangent point of the outer peripheral surface of the projection portion 44 and the first tangent line T1 and extends from the first tangent line T1 toward a direction opposite to the second central axis J2 is a first normal line N1, and a normal line of the second tangent line T2 which passes through a second tangent point P2 being a tangent point of the outer peripheral surface of the projection portion 44 and the second tangent line T2 and extends from the second tangent line T2 toward the direction opposite to the second central axis J2 is a second normal line N2. When the housing 40 is viewed from the axial direction, the second positioning portion 46b is disposed closer to the direction (−Y side) from the first central axis J1 to the second central axis J2 in the inter-axis direction than the first normal line N1 and the second normal line N2. That is, the second positioning portion 46b is disposed in the flange portion 42 in a range indicated by a symbol A in FIG. 2. In the embodiment, the second positioning portion 46b is disposed in the flange portion 42 at a position between the first tangent line T1 and the second tangent line T2, on the first tangent line T1, or on the second tangent line T2.

According to the embodiment, the first positioning portion 46a (the first convex portion 46a) and the second positioning portion 46b (the second convex portion 46b) are easily arranged at sides facing each other with the projection portion 44 clamped therebetween as viewed from the axial direction. Thereby, the precision of the coaxial degree between the housing 40 of the electric pump device 10 and the recess 101 of the mounted object 100 is further improved. Thus, the sealing performance of the seal portion 43 is further stabilized.

The positioning portions 46 (the convex portions 46) overlap the inverter case 60 as viewed from the axial direction. The inverter case 60 is disposed at the other axial side of the housing 40. For example, compared with a configuration which is different from the embodiment and in which the positioning portions 46 are disposed radially outward from the inverter case 60 as viewed from the axial direction, in the embodiment, the outer diameter of the flange portion 42 can be kept small. Therefore, the electric pump device 10 can be reduced in size.

As shown in FIG. 3, an axial length L2 at which the positioning portions 46 and the mounting surface positioning portions 111 are fitted, that is, an axial length L2 at which the convex portions 46 are inserted into the insertion holes 111, is smaller than an axial length L1 at which the projection portion 44 is inserted into the in-port 102. According to the embodiment, when the electric pump device 10 and the mounted object 100 are assembled, first, the projection portion 44 is fitted to the in-port 102, and then the positioning portions 46 and the mounting surface positioning portions 111 can be fitted. Therefore, the electric pump device 10 and the mounted object 100 are more easily assembled.

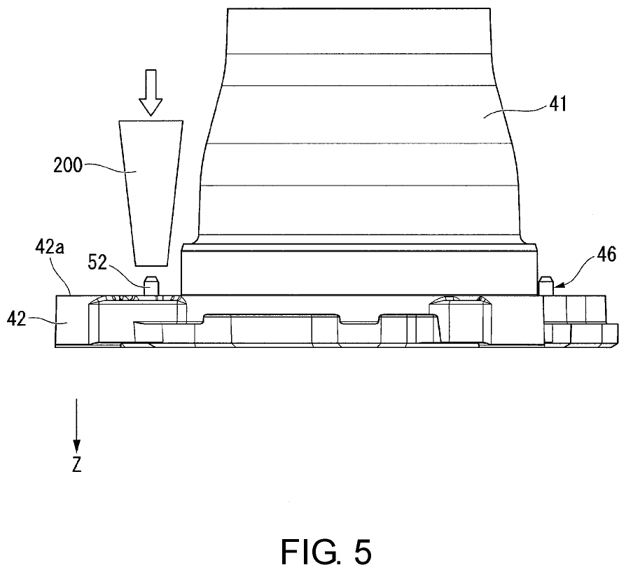

As shown in FIG. 4, the hole portions 51 are disposed in the flange portion body 42b. The hole portions 51 are recessed from the end surface 42a facing the one axial side of the flange 42 toward the other axial side. The hole portions 51 have a crested circular hole shape. The pin portions 52 are disposed on the flange portion body 42b. The pin portions 52 are fixed to the flange portion 42 by being fitted into the hole portions 51 and are projected from the end surface 42a toward the one axial side. That is, the pin portions 52 are fixed to the hole portions 51 by press fitting. The pin portions 52 have a circular column shape. The convex portions 46 (the positioning portions 46) are parts of the pin portions 52 which are projected from the end surface 42a toward the one axial side. As shown in FIG. 5, the pin portions 52 are press-fitted into the hole portions 51 by using a columnar press-fitting jig 200. An axial length of the press-fitting jig 200 is smaller than an axial length of the housing body portion 41.

According to the embodiment, the convex portions 46 are configured by the pin portions 52. Since the pin portions 52 are press-fitted into the flange portion 42 of the housing 40 instead of the mounting surface 110 of the mounted object 100, the pin portions 52 can be precisely erected along the axial direction. That is, the housing 40 has a smaller outer shape and is lighter in weight than the mounted object 100, and thus the housing 40 can be easily handled as a member, and the work of press-fitting the pin portions 52 into the flange portion 42 is easy. Therefore, press-fitting precision of the pin portions 52 can be stably improved. Thus, assembly becomes easier and the coaxial degree between the housing 40 and the recess 101 is improved. In addition, the press-fitting jig 200 or press-fitting equipment for press-fitting the pin portions 52 into the flange portion 42 can be made compactly, simply and inexpensively.

As shown in FIG. 1-FIG. 4, the mounting holes 48 are disposed in the mounting portion 42c. The mounting holes 48 pass through the flange portion 42 in the axial direction. A plurality of the mounting holes 48 is arranged. Each mounting hole 48 is disposed on each mounting portion 42c. The screw members 105 are inserted into the mounting holes 48.

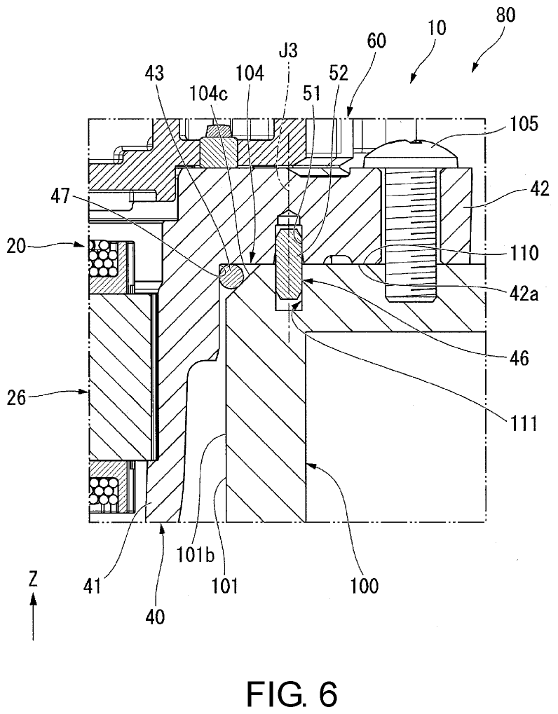

FIG. 6 is a longitudinal cross-sectional view showing a first modification example of the electric pump device 10 and the mounting structure of electric pump 80 of the embodiment. In the first modification example, the corner 104 of the mounted object 100 has an inclined surface 104c which is positioned radially inward toward the one axial side. The seal portion 43 is disposed clamped between the inclined surface 104c of the corner 104 and the corner portion 47 of the housing 40. In this case, processing of the corner 104 is easy and the sealing performance of the seal portion 43 is stabilized.

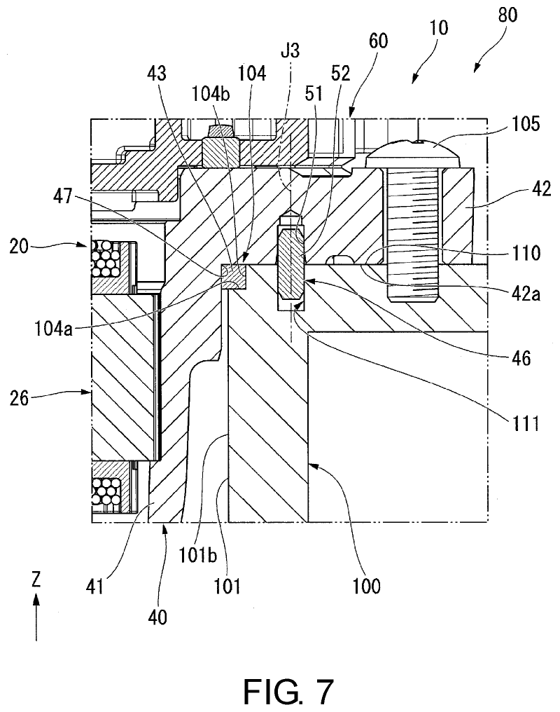

FIG. 7 is a longitudinal cross-sectional view showing a second modification example of the electric pump device 10 and the mounting structure of electric pump 80 of the embodiment. In the second modification example, the seal portion 43 has a quadrangular cross section along the radial direction. In this case, the posture of the seal portion 43 disposed at the corner 104 of the mounted object 100 is stabilized. A contact area between the seal portion 43 and the bottom wall 104a and the inner peripheral wall 104b increases. Therefore, the sealing performance of the seal portion 43 is stabilized.

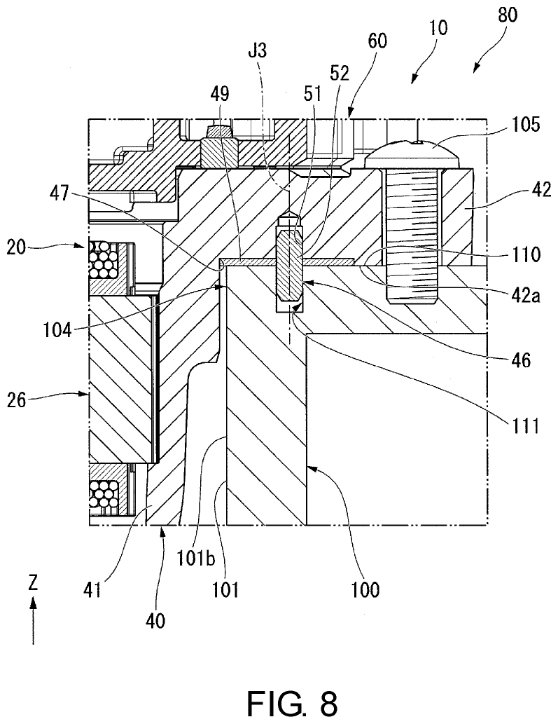

FIG. 8 is a longitudinal cross-sectional view showing a third modification example of the electric pump device 10 and the mounting structure of electric pump 80 of the embodiment. In the third modified example, a seal portion 49 has a plate shape, and a pair of plate surfaces faces the axial direction. The seal portion 49 has an annular plate shape centered on the first central axis J1. The seal portion 49 is disposed at the corner portion 47 where the outer peripheral surface of the housing body portion 41 and the end surface 42a facing the one axial side of the flange portion 42 are connected. The seal portion 49 is disposed clamped between the corner 104 and the corner portion 47. The seal portion 49 seals the space between the corner 104 and the corner portion 47. In this case, it is unnecessary to process the corner 104 of the mounted object 100 for arranging the seal portion 49.

As shown in FIG. 3, the inverter case 60 houses the inverter 50. The inverter case 60 includes a bus bar holder 61 and a cover 62. The bus bar holder 61 is fixed to the other axial side of the housing 40. The bus bar holder 61 holds the wiring members 56 and the bus bars 58. The bus bar holder 61 is made, for example, by insert molding using the wiring members 56 and the bus bars 58 as insert members. The bus bar holder 61 includes a bottom wall portion 61a, a bearing holder 61e, a ring-shaped portion 61b, support portions 61c, and a connector portion 61d.

The bottom wall portion 61a has a plate shape expanding in a direction orthogonal to the first central axis J1. The bottom wall portion 61a is fixed to a surface of the housing 40 facing the other axial side. The bearing holder 61e has a tube shape and is fixed to the bottom wall portion 61a. The bearing holder 61e is made of metal and holds the second bearing 12. The second bearing 12 is fitted into the bearing holder 61e. The ring-shaped portion 61b is projected from a radially outer edge portion of the bottom wall portion 61a toward the other axial side. The ring-shaped portion 61b has a ring shape surrounding the first central axis J1. The support portions 61c are disposed on a radially inner side of the ring-shaped portion 61b and are projected from the bottom wall portion 61a toward the other axial side. A plurality of the support portions 61c is arranged. The connector portion 61d is arranged on a radially outer surface of the ring-shaped portion 61b. As shown in FIG. 2, the connector portion 61d is projected from the ring-shaped portion 61b toward a direction from the second central axis J2 toward the first central axis J1 (+Y side) in the inter-axis direction. For example, an external power supply which supplies power to the stator portion 26 is connected to the connector portion 61d.

As shown in FIG. 3, the cover 62 is fixed to the other axial side of the bus bar holder 61. The cover 62 has a plurality of fins 62a.

The circuit board 55 has a plate shape whose plate surfaces face the axial direction. The circuit board 55 is positioned on the other axial side of the stator portion 26. The circuit board 55 is supported from the one axial side by the plurality of support portions 61c and is fixed to the plurality of support portions 61c by screws. Thereby, the circuit board 55 is supported by the bus bar holder 61. A surface on the other axial side of the circuit board 55 is positioned closer to the other axial side than the ring-shaped portion 61b.

The wiring members 56 and the bus bars 58 are connected to the circuit board 55. Parts of the wiring members 56 are embedded and held in the bus bar holder 61. The wiring members 56 are elongated plate-like members. A plurality of the wiring members 56 is arranged. The wiring members 56 pass through the connector 61d and have terminal portions (not shown) which are exposed to the outside of the inverter case 60 from the connector portion 61d. The wiring members 56 are electrically connected, through the terminal portions, to the external power supply connected to the connector portion 61d.

Parts of the bus bars 58 are embedded and held in the bus bar holder 61. The bus bars 58 are elongated plate-like members. A plurality of the bus bars 58 is arranged. The bus bars 58 are connected to the lead wire portions 29c extending from the coils 29 toward the other axial side. Thereby, the wiring members 56 are electrically connected to the stator portion 26 via the circuit board 55 and the bus bars 58.

The inverter 50 is electrically connected to the motor 20. The inverter 50 is mounted to the circuit board 55. In the embodiment, the inverter 50 is mounted to a surface on the one axial side of the circuit board 55. The inverter 50 includes a plurality of transistors 50a. The transistors 50a are, for example, field effect transistors. The inverter 50 is electrically connected to the stator portion 26 via the bus bars 58 connected to the circuit board 55.

The capacitor 57 is an electronic component which is mounted to the surface on the other axial side of the circuit board 55. The capacitor 57 is projected from the circuit board 55 toward the other axial side. The capacitor 57 has a circular column shape extending along a virtual plane (not shown) perpendicular to the first central axis J1. The capacitor 57 is electrically connected to the inverter 50 via the circuit board 55. Thereby, the capacitor 57 is electrically connected to the stator portion 26 via the circuit board 55, the inverter 50, and the bus bars 58.

As shown in FIG. 1, the breather 59 is arranged on the cover 62. The breather 59 has a breathing hole (not shown). The breather 59 has a function of extracting air inside the inverter case 60 to the outside through the breathing hole.

Moreover, the disclosure is not limited to the above-described embodiment, and for example, as described below, change of the configuration or the like is possible in a scope not departing from the spirit of the disclosure.

In the above-described embodiment, the pin portions 52 are fixed to the hole portions 51 by press-fitting, and the parts of the pin portions 52 which are projected from the end surface 42a toward the one axial side are the convex portions 46 (the positioning portions 46); however, the disclosure is not limited thereto. The convex portions 46 and the flange portion 42 may be part of a single member. In this case, the convex portions 46 are arranged integrally with the flange portion 42 when, for example, the housing body portion 41 is cast.

Additionally, in the scope not departing from the spirit of the disclosure, each configuration (constituent element) described in the above-described embodiment, modification examples, rewriting and the like may be combined; besides, additions, omissions, substitutions and other changes can be made. In addition, the disclosure is not limited to the above-described embodiment, and is limited only by the scope of the claims.

The embodiments of the disclosure are described in detail with reference to the accompanying drawings, which illustrate the examples to which the principles of the disclosure are applicable. It should be understood that the embodiments of the disclosure are not limited to those described above, but shall cover all variations, modifications, and equivalents within the scope of the disclosure.

Features of the above-described preferred embodiments and the modifications thereof may be combined appropriately as long as no conflict arises. While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. An electric pump device, comprising:
a motor having a shaft extending along a first central axis;
a pump portion driven by the motor; and
a housing for housing the motor and the pump portion,
wherein the housing comprises:
a housing body portion which has a bottomed tube shape and extends in an axial direction,
a flange portion which expands radially outward from an outer peripheral surface of the housing body portion,
a seal portion which has a ring shape extending in a circumferential direction and is arranged at a corner portion in which the outer peripheral surface of the housing body portion and an end surface facing one axial side of the flange portion are connected, and
a projection portion extending from a bottom portion of the housing body portion toward one axial side;
a second central axis of the projection portion is arranged at a position shifted in a radial direction from the first central axis;
the flange portion has positioning portions on an end surface facing the one axial side of the flange portion; and
the positioning portions have a convex shape projected from the end surface facing the one axial side of the flange portion toward the one axial side or a hole shape recessed from the end surface toward the other axial side.

2. The electric pump device according to claim 1, wherein
when the housing is viewed from the axial direction, a direction along which a virtual straight line passing through the first central axis and the second central axis extends is defined as an inter-axis direction; and
the positioning portions are arranged closer to a direction from the second central axis toward the first central axis of the inter-axis direction than the projection portion.

3. The electric pump device according to claim 1, wherein
two positioning portions are arranged in the flange portion.

4. The electric pump device according to claim 3, wherein
the two positioning portions are a first positioning portion and a second positioning portion;
when the housing is viewed from the axial direction,
two tangent lines which pass through a third central axis of the first positioning portion and are tangent to the outer peripheral surface of the projection portion are a first tangent line and a second tangent line;
a normal line of the first tangent line which passes through a first tangent point being a tangent point of the outer peripheral surface of the projection portion and the first tangent line and extends from the first tangent line toward a direction opposite to the second central axis is a first normal line;
a normal line of the second tangent line which passes through a second tangent point being a tangent point of the outer peripheral surface of the projection portion and the second tangent line and extends from the second tangent line toward a direction opposite to the second central axis is a second normal line;
the direction along which the virtual straight line passing through the first central axis and the second central axis extends is defined as the inter-axis direction; and
the second positioning portion is arranged closer to a direction from the first central axis toward the second central axis of the inter-axis direction than the first normal line and the second normal line.

5. The electric pump device according to claim 1, comprising:
an inverter electrically connected to the motor; and
an inverter case for housing the inverter,
wherein the inverter case is arranged at the other axial side of the housing, and
the positioning portions overlap the inverter case when viewed from the axial direction.

6. The electric pump device according to claim 1, wherein
the seal portion has a plate shape, and a pair of plate surfaces faces the axial direction.

7. A mounting structure of electric pump, comprising:
the electric pump device according to claim 1; and
a mounted object to which the electric pump device is mounted,
wherein the mounted object comprises:
a mounting surface facing the other axial side and in contact with an end surface facing one axial side of the flange portion;
a recess which is recessed from the mounting surface toward one axial side and into which the housing body portion is inserted;
an in-port which opens in a bottom surface of the recess and extends in an axial direction and into which the projection portion is inserted; and
a corner which has a ring shape extending in a circumferential direction and in which an inner peripheral surface of the recess and the mounting surface are connected,
wherein the inner peripheral surface of the recess faces the outer peripheral surface of the housing body portion with a gap therebetween in the radial direction,
the seal portion is arranged clamped in the corner and the corner portion,
the mounting surface has mounting surface positioning portions into which the positioning portions are fitted, and
the mounting surface positioning portions have a hole shape recessed from the mounting surface toward one axial side or a convex shape projected from the mounting surface toward the other axial side.

8. The mounting structure of electric pump according to claim 7, wherein
an axial length at which the positioning portions and the mounting surface positioning portions are fitted is smaller than an axial length at which the projection portion is inserted into the in-port.

9. The mounting structure of electric pump according to claim 7, wherein
the corner has an inclination surface positioned radially inward toward one axial side.

10. The mounting structure of electric pump according to claim 7, wherein
the corner comprises:
a bottom wall which is positioned closer to the one axial side than the mounting surface and faces the other axial side; and
an inner peripheral wall which is positioned radially outward from the inner peripheral surface of the recess and faces radially inward.

11. The mounting structure of electric pump according to claim 10, wherein
the seal portion has a quadrangular cross section along the radial direction.
